(19) United States
(12) Patent Application Publication
(10) Pub. No.: US 2024/0413493 A1
(43) Pub. Date: Dec. 12, 2024

(54) SECONDARY BATTERY

(71) Applicant: Prime Planet Energy & Solutions, Inc., Tokyo (JP)

(72) Inventors: Shogo TACHIBANA, Himeji-shi (JP); Naoya TADA, Himeji-shi (JP)

(21) Appl. No.: 18/668,252

(22) Filed: May 20, 2024

(30) Foreign Application Priority Data
Jun. 8, 2023 (JP) 2023-094756

(51) Int. Cl. H01M 50/538; H01M 50/103; H01M 50/15; H01M 50/169; H01M 50/533; H01M 50/548; H01M 50/553

(52) U.S. Cl. CPC H01M 50/538; H01M 50/103; H01M 50/15; H01M 50/169; H01M 50/533; H01M 50/548; H01M 50/553

(57) ABSTRACT

A first sealing plate has a first end portion and a second end portion located opposite to each other in a second direction orthogonal to the first direction. A negative electrode tab group is bent at a first bent portion such that a tip side of the negative electrode tab group with respect to the first bent portion is directed to the second end portion side. The first sealing plate is provided with a first through hole in which the negative electrode terminal is inserted in the first direction. The first bent portion is located on the first end portion side with respect to a center of the first sealing plate in the second direction. A center of the first through hole is located on the second end portion side with respect to the center of the first sealing plate in the second direction.

### CROSS REFERENCE TO RELATED APPLICATIONS

This nonprovisional application is based on Japanese Patent Application No. 2023-094756 filed on Jun. 8, 2023 with the Japan Patent Office, the entire contents of which are hereby incorporated by reference.

### BACKGROUND OF THE INVENTION

### Field of the Invention

The present technology relates to a secondary battery.

### Description of the Background Art

Japanese Patent No. 4537353 is a prior art document that discloses a configuration of a secondary battery. The secondary battery described in Japanese Patent No. 4537353 includes an electrode group, a case, and a current collector portion. The electrode group is included in the case. The electrode group includes a positive electrode and a negative electrode, each of which has a non-applied portion on which no active material is applied. The non-applied portions of the positive electrode and the negative electrode are provided at respective end portions of the wound electrode group in an axial direction of the electrode group. The current collector portion includes a non-applied-portion-contacted portion and a flange portion. The non-applied-portion-contacted portion is fitted and coupled to the non-applied portion. The flange portion is coupled to an electrode terminal to support the electrode terminal.

### SUMMARY OF THE INVENTION

Since the non-applied-portion-contacted portion and the flange portion are arranged side by side in the winding axis direction of the electrode group in the current collector portion of the secondary battery described in Japanese Patent No. 4537353, an occupied width of the current collector portion in the winding axis direction to connect the electrode group and the electrode terminal becomes large. Therefore, a large occupied volume of the electrode assembly in the battery case cannot be secured, with the result that it is difficult to increase an energy density of the secondary battery.

Further, also when an electrode tab group for connecting the electrode assembly and the current collector is provided at an end portion of the electrode assembly, there is a possibility that the occupied width of the current collector portion becomes large, so that there is room for increasing the energy density of the secondary battery.

The present technology has been made to solve the above-described problem and has an object to provide a secondary battery to increase an energy density.

The present technology provides the following secondary battery.
[1]A secondary battery comprising:

an electrode assembly including a first electrode and a second electrode having a polarity different from a polarity of the first electrode;

a case that accommodates the electrode assembly; and

a first electrode terminal electrically connected to the first electrode and provided in the case, wherein

the electrode assembly includes a first electrode tab group and a second electrode tab group, the first electrode tab group being electrically connected to the first electrode, the first electrode tab group being located at an end portion of the electrode assembly on a first side in a first direction, the second electrode tab group being electrically connected to the second electrode, the second electrode tab group being located at an end portion of the electrode assembly on a second side opposite to the first side in the first direction,

the case includes a case main body provided with a first opening located at an end portion of the case main body on the first side in the first direction, and a first sealing plate that seals the first opening,

the first sealing plate has a first end portion and a second end portion located opposite to each other in a second direction orthogonal to the first direction,

the first electrode tab group has a first bent portion that is collectively bent, and a first tip side region located on a tip side of the first electrode tab group with respect to the first bent portion,

the first electrode tab group is bent at the first bent portion such that the tip side of the first electrode tab group with respect to the first bent portion is directed to the second end portion side,

the first tip side region is electrically connected to the first electrode terminal,

the first sealing plate is provided with a first through hole in which the first electrode terminal is inserted in the first direction,

the first bent portion is located on the first end portion side with respect to a center of the first sealing plate in the second direction, and

a center of the first through hole is located on the second end portion side with respect to the center of the first sealing plate in the second direction.
[2]The secondary battery according to [1], further comprising a second electrode terminal electrically connected to the second electrode and provided in the case, wherein

the case includes a second sealing plate,

the case main body is provided with a second opening located at an end portion of the case main body on the second side in the first direction,

the second sealing plate seals the second opening,

the second sealing plate has a third end portion and a fourth end portion located opposite to each other in the second direction,

the second electrode tab group has a second bent portion that is collectively bent, and a second tip side region located on a tip side of the second electrode tab group with respect to the second bent portion,

the second electrode tab group is bent at the second bent portion such that the tip side of the second electrode tab group with respect to the second bent portion is directed to the second end portion side,

the second tip side region is electrically connected to the second electrode terminal,

the second sealing plate is provided with a second through hole in which the second electrode terminal is inserted in the first direction,

the second bent portion is located on the third end portion side with respect to a center of the second sealing plate in the second direction, and

a center of the second through hole is located on the fourth end portion side with respect to the center of the second sealing plate in the second direction.
[3]The secondary battery according to [2], wherein in the second direction, the first end portion and the third end portion are located on the same end portion side.
[4]The secondary battery according to any one of [1] to [3], further comprising a first current collector member that electrically connects the first electrode terminal and the first electrode tab group, wherein

the first current collector member includes a first component and a second component,

the second component is connected to the first electrode terminal,

the first component has a first region connected to the second component and a second region connected to the first electrode tab group,

a stepped portion is provided between the first region and the second region such that positions of the first region and the second region in the first direction are different from each other, and

the stepped portion extends along a third direction orthogonal to the first direction and the second direction.
[5]The secondary battery according to [4], wherein the second region of the first component is disposed along the first sealing plate.
[6]The secondary battery according to any one of [1] to [5], further comprising a resin member disposed between the first electrode terminal and the first sealing plate, wherein

the first sealing plate further has a covering portion that covers, in the first direction, the end portion of the case main body on the first side, and

the covering portion and the case main body are joined by welding.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a configuration of a secondary battery according to one embodiment of the present technology.

FIG. 2 is a diagram showing a state in which the secondary battery shown in FIG. 1 is viewed in a direction of arrow II.

FIG. 3 is a diagram showing a state in which the secondary battery shown in FIG. 1 is viewed in a direction of arrow III.

FIG. 4 is a diagram showing a state in which the secondary battery shown in FIG. 1 is viewed in a direction of arrow IV.

FIG. 5 is a front cross sectional view of the secondary battery shown in FIG. 1.

FIG. 6 is a front view showing a negative electrode raw plate before a negative electrode plate is formed.

FIG. 7 is a cross sectional view of the negative electrode raw plate shown in FIG. 6 along VII-VII.

FIG. 8 is a front view showing the negative electrode plate formed from the negative electrode raw plate.

FIG. 9 is a front view showing a positive electrode raw plate before a positive electrode plate is formed.

FIG. 10 is a cross sectional view of the positive electrode raw plate shown in FIG. 9 along X-X.

FIG. 11 is a front view showing the positive electrode plate formed from the positive electrode raw plate.

FIG. 12 is a diagram showing an electrode assembly and a current collector each removed from the secondary battery.

FIG. 13 is a front view of a connection structure between a negative electrode tab group and a negative electrode current collector.

FIG. 14 is a cross sectional view of the connection structure between the negative electrode tab group and the negative electrode current collector.

FIG. 15 is a diagram showing a step of inserting the electrode assembly into a case main body.

FIG. 16 is a diagram showing a step of disposing a spacer between a sealing plate and the electrode assembly.

FIG. 17 is a partial cross sectional view of the secondary battery according to the embodiment when viewed from above.

FIG. 18 is a perspective view showing a joining state between a case main body and a first sealing plate included in a secondary battery according to a first modification of the embodiment.

FIG. 19 is a partial cross sectional view showing a configuration of a secondary battery according to a second modification of the embodiment.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “secondary battery” is not limited to a lithium ion battery, and may include other secondary batteries such as a nickel-metal hydride battery and a sodium-ion battery. In the present specification, the term “electrode” may collectively represents a positive electrode and a negative electrode.

It should be noted that in the figures, it is defined that: an X direction serving as a first direction represents a direction along a winding axis of an electrode assembly included in the secondary battery; a Y direction serving as a second direction represents a short-side direction of the electrode assembly when viewed in the first direction, the second direction being orthogonal to the first direction; and a Z direction serving as a third direction represents a long-side direction of the electrode assembly when viewed in the first direction, the third direction being orthogonal to the first direction. In order to facilitate understanding of the invention, the size of each component in the figures may be illustrated to be changed from its actual size.

In the specification of the present application, the first direction (X direction) may be referred to as a “width direction” of the secondary battery or the case main body, the second direction (Y direction) may be referred to as a “thickness direction” of the secondary battery or the case main body, and the third direction (Z direction) may be referred to as a “height direction” of the secondary battery or the case main body.

### Overall Configuration of Battery

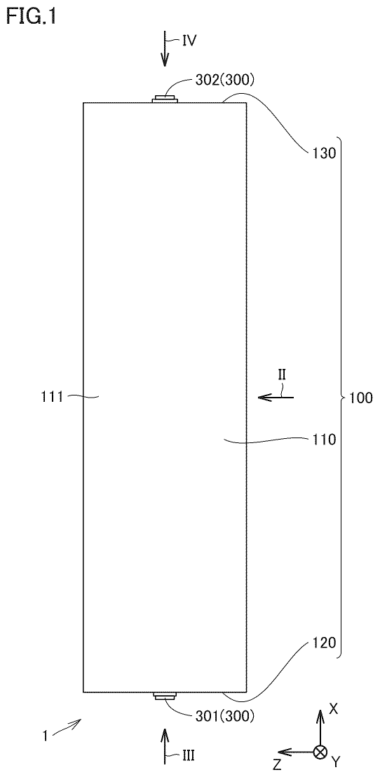

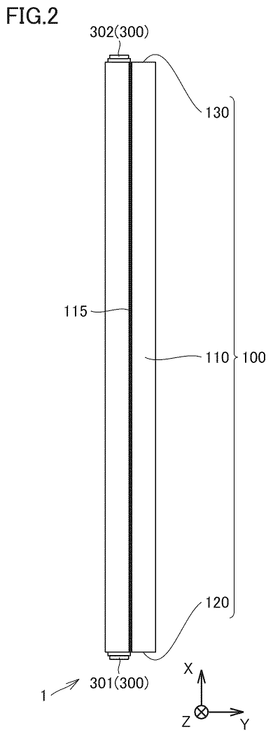

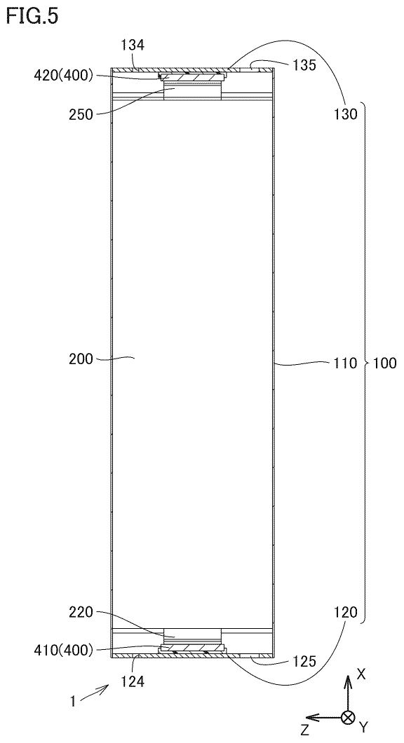

FIG. 1 is a front view of a secondary battery 1 according to the present embodiment. FIGS. 2 to 4 are diagrams showing states of secondary battery 1 shown in FIG. 1 when viewed in directions of arrows II, III, and IV, respectively. FIG. 5 is a front cross sectional view of secondary battery 1 shown in FIG. 1.

Secondary battery 1 can be mounted on a battery electric vehicle (BEV), a plug-in hybrid electric vehicle (PHEV), a hybrid electric vehicle (HEV), or the like. It should be noted that the purpose of use of secondary battery 1 is not limited to the use on a vehicle.

As shown in FIGS. 1 to 5, secondary battery 1 includes a case 100, an electrode assembly 200, electrode terminals 300, and current collectors 400. Case 100 includes a case main body 110, a first sealing plate 120, and a second sealing plate 130.

When forming a battery assembly including secondary battery 1, a plurality of secondary batteries 1 are stacked in the thickness direction of each of the plurality of secondary batteries 1. Secondary batteries 1 stacked may be restrained in the stacking direction (Y direction) by a restraint member to form a battery module, or the battery assembly may be directly supported by a side surface of a case of a battery pack without using the restraint member.

Case main body 110 is constituted of a member having a tubular shape, preferably, a prismatic tubular shape. Thus, secondary battery 1 having a prismatic shape is obtained. Case main body 110 is composed of a metal. Specifically, case main body 110 is composed of aluminum, an aluminum alloy, iron, an iron alloy, or the like.

As shown in FIGS. 1 and 2, first sealing plate 120 and second sealing plate 130 are provided at respective end portions of the case main body. Case main body 110 can be formed to have a prismatic tubular shape in, for example, the following manner: end sides of a plate-shaped member having been bent are brought into abutment with each other (joining portion 115 illustrated in FIG. 2) and are joined together (for example, laser welding). Each of the corners of the “prismatic tubular shape” may have a shape with a curvature.

In the present embodiment, case main body 110 is formed to be longer in the width direction (X direction) of secondary battery 1 than in each of the thickness direction (Y direction) and the height direction (Z direction) of secondary battery 1. The size (width) of case main body 110 in the X direction is preferably about 30 cm or more. In this way, secondary battery 1 can be formed to have a relatively large size (high capacity). The size (height) of case main body 110 in the Z direction is preferably about 20 cm or less, more preferably about 15 cm or less, and further preferably about 10 cm or less. Thus, (low-height) secondary battery 1 having a relatively low height can be formed, thus resulting in improved ease of mounting on a vehicle, for example.

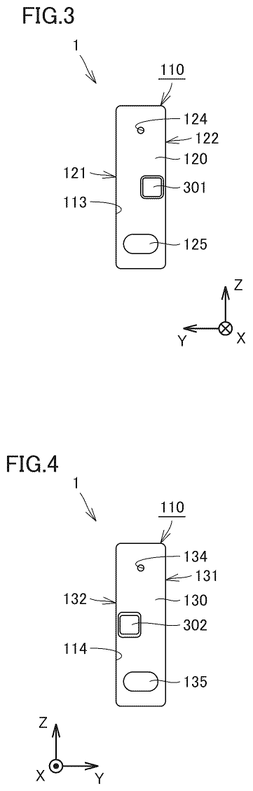

As shown in FIG. 3, a first opening 113 is provided at an end portion of case main body 110 on a first side in the first direction (X direction). First opening 113 is sealed by first sealing plate 120. Each of first opening 113 and first sealing plate 120 has a substantially rectangular shape in which the Y direction corresponds to its short-side direction and the Z direction corresponds to its long-side direction. First sealing plate 120 has a first end portion 121 and a second end portion 122 located opposite to each other in the second direction (Y direction).

First sealing plate 120 is provided with a negative electrode terminal 301 (first electrode terminal), a liquid injection hole 124, and a gas-discharge valve 125. The positions of negative electrode terminal 301, liquid injection hole 124, and gas-discharge valve 125 can be appropriately changed.

As shown in FIG. 4, a second opening 114 is provided at an end portion of case main body 110 on a second side in the first direction (X direction). Second opening 114 is sealed by second sealing plate 130. Each of second opening 114 and second sealing plate 130 has a substantially rectangular shape in which the Y direction corresponds to its short-side direction and the Z direction corresponds to its long-side direction. Second sealing plate 130 has a third end portion 131 and a fourth end portion 132 located opposite to each other in the second direction.

Second sealing plate 130 is provided with a positive electrode terminal 302 (second electrode terminal), a liquid injection hole 134, and a gas-discharge valve 135. The positions of positive electrode terminal 302, liquid injection hole 134, and gas-discharge valve 135 can be appropriately changed.

As shown in FIGS. 3 and 4, in the second direction (Y direction), first end portion 121 of first sealing plate 120 and third end portion 131 of second sealing plate 130 are located on the same end portion side. In the second direction (Y direction), second end portion 122 of first sealing plate 120 and fourth end portion 132 of second sealing plate 130 are located on the same end portion side.

Each of first sealing plate 120 and second sealing plate 130 is composed of a metal. Specifically, each of first sealing plate 120 and second sealing plate 130 is composed of aluminum, an aluminum alloy, iron, an iron alloy, or the like.

Negative electrode terminal 301 is electrically connected to a negative electrode of electrode assembly 200. Negative electrode terminal 301 is located on an outer surface of first sealing plate 120, i.e., on an outer surface of case 100.

Positive electrode terminal 302 is electrically connected to a positive electrode of electrode assembly 200. Positive electrode terminal 302 is located on an outer surface of second sealing plate 130, i.e., on an outer surface of case 100.

Negative electrode terminal 301 is composed of a conductive material (more specifically, a metal), and can be composed of copper, a copper alloy, or the like, for example. A portion or layer composed of aluminum or an aluminum alloy may be provided at a portion of an outer surface of negative electrode terminal 301.

Positive electrode terminal 302 is composed of a conductive material (more specifically, a metal), and can be composed of aluminum, an aluminum alloy, or the like, for example.

Each of liquid injection holes 124, 134 is sealed by a sealing member (not shown). As the sealing member, for example, a blind rivet or another metal member can be used.

Each of gas-discharge valves 125, 135 is fractured to discharge a gas in case 100 to outside when pressure in case 100 becomes equal to or more than a predetermined value.

Electrode assembly 200 is an electrode assembly having a flat shape and having a below-described positive electrode plate and a below-described negative electrode plate. Specifically, electrode assembly 200 is a wound type electrode assembly in which a strip-shaped positive electrode plate and a strip-shaped negative electrode plate are both wound with a strip-shaped separator (not shown) being interposed therebetween. It should be noted that in the present specification, the “electrode assembly” is not limited to the wound type electrode assembly, and may be a stacked type electrode assembly in which a plurality of positive electrode plates and a plurality of negative electrode plates are alternately stacked. The electrode assembly may include a plurality of positive electrode plates and a plurality of negative electrode plates, respective positive electrode tabs provided in the positive electrode plates may be stacked to form a positive electrode tab group, and respective negative electrode tabs provided in the negative electrode plates may be stacked to form a negative electrode tab group.

As shown in FIG. 5, case 100 accommodates electrode assembly 200. Electrode assembly 200 is accommodated in case 100 such that the winding axis thereof is parallel to the X direction.

Specifically, one or a plurality of the wound type electrode assemblies and an electrolyte solution (electrolyte) (not shown) are accommodated inside a below-described insulating sheet 700 disposed in case 100. As the electrolyte solution (non-aqueous electrolyte solution), it is possible to use, for example, a solution obtained by dissolving LiPF₆ at a concentration of 1.2 mol/L in a non-aqueous solvent obtained by mixing ethylene carbonate (EC), ethyl methyl carbonate (EMC), and diethyl carbonate (DEC) at a volume ratio (25° C.) of 30:30:40. It should be noted that instead of the electrolyte solution, a solid electrolyte may be used.

Electrode assembly 200 includes a negative electrode tab group 220 (first electrode tab group) and a positive electrode tab group 250 (second electrode tab group). Negative electrode tab group 220 is located at an end portion of electrode assembly 200 on the first side in the first direction (X direction). The first side in the present embodiment is the first sealing plate 120 side. Positive electrode tab group 250 is located at an end portion of electrode assembly 200 on a second side opposite to the first side in the first direction (X direction). The second side in the present embodiment is the second sealing plate 130 side.

Each of negative electrode tab group 220 and positive electrode tab group 250 is formed to protrude from a central portion of electrode assembly 200 toward first sealing plate 120 or second sealing plate 130. It should be noted that the manner of protruding of each of negative electrode tab group 220 and positive electrode tab group 250 is not limited to such a manner.

Current collector 400 includes a negative electrode current collector 410 (first current collector) and a positive electrode current collector 420 (second current collector). Each of negative electrode current collector 410 and positive electrode current collector 420 is constituted of a plate-shaped member. Electrode assembly 200 is electrically connected to negative electrode terminal 301 and positive electrode terminal 302 through current collectors 400. It should be noted that negative electrode tab group 220 can be directly connected to negative electrode terminal 301. Positive electrode tab group 250 can be directly connected to positive electrode terminal 302.

Negative electrode current collector 410 is disposed on first sealing plate 120 with an insulating member composed of a resin being interposed therebetween. Negative electrode current collector 410 is electrically connected to negative electrode tab group 220 and negative electrode terminal 301. Negative electrode current collector 410 is composed of a conductive material (more specifically, a metal), and can be composed of copper, a copper alloy, or the like, for example.

Positive electrode current collector 420 is disposed on second sealing plate 130 with an insulating member composed of a resin being interposed therebetween. Positive electrode current collector 420 is electrically connected to positive electrode tab group 250 and positive electrode terminal 302. Positive electrode current collector 420 is composed of a conductive material (more specifically, a metal), and can be composed of aluminum, an aluminum alloy, or the like, for example.

### Configuration of Electrode Assembly 200

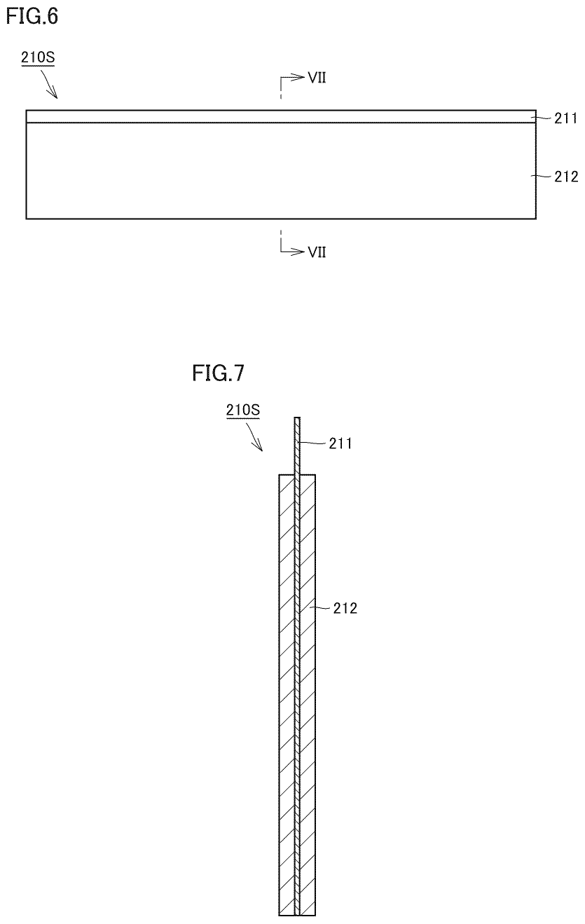

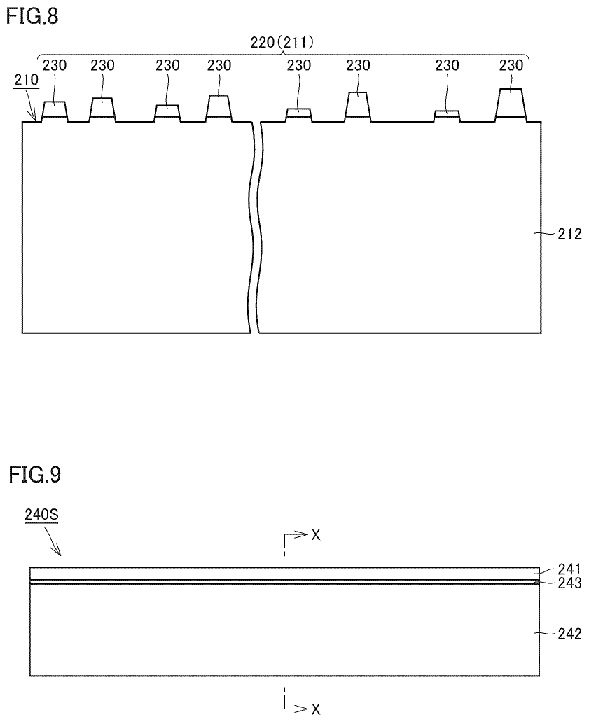

FIG. 6 is a front view showing a negative electrode raw plate 210S before negative electrode plate 210 (first electrode) is formed, FIG. 7 is a cross sectional view of negative electrode raw plate 210S shown in FIG. 6 along VII-VII, and FIG. 8 is a front view showing negative electrode plate 210 formed from negative electrode raw plate 210S.

Negative electrode plate 210 is manufactured by processing negative electrode raw plate 210S. As shown in FIGS. 6 and 7, negative electrode raw plate 210S includes a negative electrode core body 211 and a negative electrode active material layer 212. Negative electrode core body 211 is a copper foil or a copper alloy foil.

Negative electrode active material layer 212 is formed on negative electrode core body 211 except for each of end portions of both surfaces of negative electrode core body 211 on one side. Negative electrode active material layer 212 is formed by applying a negative electrode active material layer slurry using a die coater.

The negative electrode active material layer slurry is produced by kneading graphite serving as a negative electrode active material, styrene-butadiene rubber (SBR) and carboxymethyl cellulose (CMC) each serving as a binder, and water serving as a dispersion medium such that the mass ratio of the graphite, the SBR, and the CMC is about 98:1:1.

Negative electrode core body 211 having the negative electrode active material layer slurry applied thereon is dried to remove the water included in the negative electrode active material layer slurry, thereby forming negative electrode active material layer 212. Further, by compressing negative electrode active material layer 212, negative electrode raw plate 210S including negative electrode core body 211 and negative electrode active material layer 212 is formed. Negative electrode raw plate 210S is cut into a predetermined shape, thereby forming negative electrode plate 210. Negative electrode raw plate 210S can be cut by laser processing with application of an energy ray, die processing, cutter processing, or the like.

As shown in FIG. 8, a plurality of negative electrode tabs 230 each constituted of negative electrode core body 211 are provided at one end portion, in the width direction, of negative electrode plate 210 formed from negative electrode raw plate 210S. When negative electrode plate 210 is wound, the plurality of negative electrode tabs 230 are stacked to form negative electrode tab group 220. Thus, negative electrode tab group 220 is connected to negative electrode plate 210 (first electrode). The position of each of the plurality of negative electrode tabs 230 and the length thereof in the protruding direction are appropriately adjusted in consideration of the state in which negative electrode tab group 220 is connected to negative electrode current collector 410. It should be noted that the shape of negative electrode tab 230 is not limited to the one illustrated in FIG. 8.

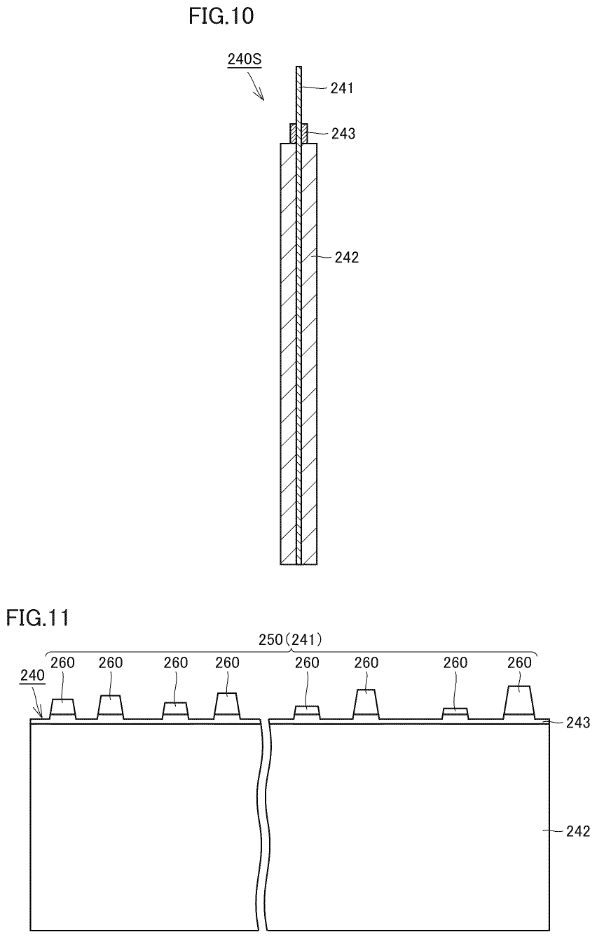

FIG. 9 is a front view showing a positive electrode raw plate 240S before positive electrode plate 240 (second electrode) is formed, FIG. 10 is a cross sectional view of positive electrode raw plate 240S shown in FIG. 9 along X-X, and FIG. 11 is a front view showing positive electrode plate 240 formed from positive electrode raw plate 240S.

Positive electrode plate 240 serving as the second electrode has a polarity different from a polarity of negative electrode plate 210 serving as the first electrode. Positive electrode plate 240 is manufactured by processing positive electrode raw plate 240S. As shown in FIGS. 9 and 10, positive electrode raw plate 240S includes a positive electrode core body 241, a positive electrode active material layer 242, and a positive electrode protective layer 243. Positive electrode core body 241 is an aluminum foil or an aluminum alloy foil.

Positive electrode active material layer 242 is formed on positive electrode core body 241 except for each of end portions of both surfaces of positive electrode core body 241 on one side. Positive electrode active material layer 242 is formed on positive electrode core body 241 by applying a positive electrode active material layer slurry using a die coater.

The positive electrode active material layer slurry is produced by kneading a lithium-nickel-cobalt-manganese composite oxide serving as a positive electrode active material, polyvinylidene difluoride (PVdF) serving as a binder, a carbon material serving as a conductive material, and N-methyl-2-pyrrolidone (NMP) serving as a dispersion medium such that the mass ratio of the lithium-nickel-cobalt-manganese composite oxide, the PVdF, and the carbon material is about 97.5:1:1.5.

Positive electrode protective layer 243 is formed in contact with positive electrode core body 241 at an end portion of positive electrode active material layer 242 on the one side in the width direction. Positive electrode protective layer 243 is formed on positive electrode core body 241 by applying a positive electrode protective layer slurry using a die coater. Positive electrode protective layer 243 has an electrical resistance larger than that of positive electrode active material layer 242.

The positive electrode protective layer slurry is produced by kneading alumina powder, a carbon material serving as a conductive material, PVdF serving as a binder, and NMP serving as a dispersion medium such that the mass ratio of the alumina powder, the carbon material, and the PVdF is about 83:3:14.

Positive electrode core body 241 having the positive electrode active material layer slurry and the positive electrode protective layer slurry applied thereon is dried to remove the NMP included in the positive electrode active material layer slurry and the positive electrode protective layer slurry, thereby forming positive electrode active material layer 242 and positive electrode protective layer 243. Further, by compressing positive electrode active material layer 242, positive electrode raw plate 240S including positive electrode core body 241, positive electrode active material layer 242, and positive electrode protective layer 243 is formed. Positive electrode raw plate 240S is cut into a predetermined shape, thereby forming positive electrode plate 240. Positive electrode raw plate 240S can be cut by laser processing with application of an energy ray, die processing, cutter processing, or the like.

As shown in FIG. 11, a plurality of positive electrode tabs 260 each constituted of positive electrode core body 241 are provided at one end portion, in the width direction, of positive electrode plate 240 formed from positive electrode raw plate 240S. When positive electrode plate 240 is wound, the plurality of positive electrode tabs 260 are stacked to form positive electrode tab group 250. Thus, positive electrode tab group 250 is connected to positive electrode plate 240 (second electrode). The position of each of the plurality of positive electrode tabs 260 and the length thereof in the protruding direction are appropriately adjusted in consideration of the state in which positive electrode tab group 250 is connected to positive electrode current collector 420. It should be noted that the shape of positive electrode tab 260 is not limited to the one illustrated in FIG. 11.

Positive electrode protective layer 243 is provided at the root of each of the plurality of positive electrode tabs 260. Positive electrode protective layer 243 may not necessarily be provided at the root of positive electrode tab 260.

In a typical example, the thickness of (one) negative electrode tab 230 is smaller than the thickness of (one) positive electrode tab 260. In this case, the thickness of negative electrode tab group 220 is smaller than the thickness of positive electrode tab group 250.

### Connection Structure Between Electrode Assembly 200 and Current Collector 400

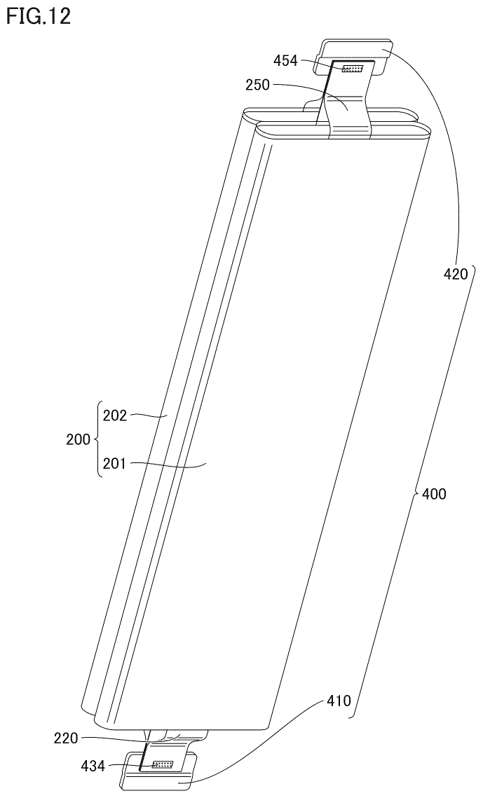

FIG. 12 is a diagram showing electrode assembly 200 and current collector 400 each removed from secondary battery 1. As shown in FIG. 12, electrode assembly 200 is formed by stacking two electrode assemblies 201, 202, each of which is a wound type electrode assembly. Although FIG. 12 illustratively shows the structure in which two wound type electrode assemblies are stacked, electrode assembly 200 may be constituted of one wound type electrode assembly, may be constituted of three or more wound type electrode assemblies, or may be constituted of a stacked type electrode assembly.

Negative electrode tab group 220 is joined to negative electrode current collector 410 at a joining portion 434 and positive electrode tab group 250 is joined to positive electrode current collector 420 at a joining portion 454.

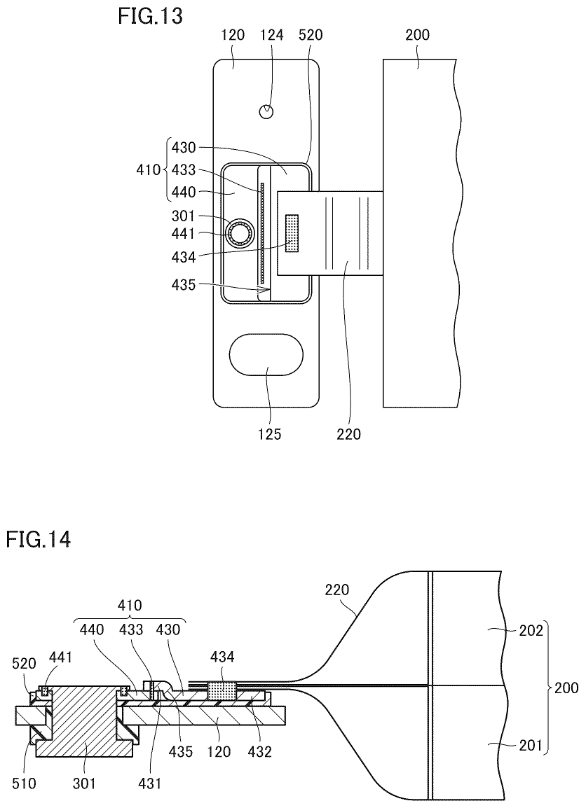

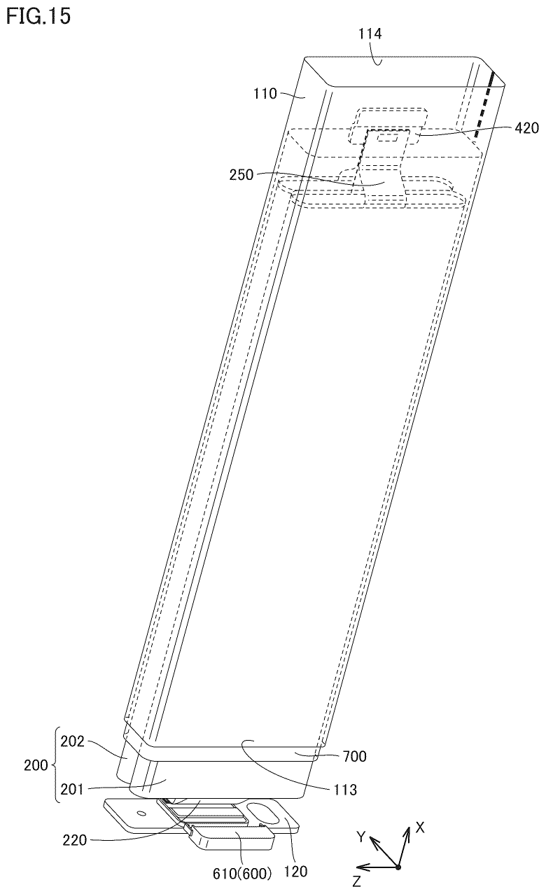

FIG. 13 is a front view of a connection structure between the negative electrode tab group and the negative electrode current collector. FIG. 14 is a cross sectional view of the connection structure between the negative electrode tab group and the negative electrode current collector.

As shown in FIGS. 13 and 14, negative electrode current collector 410 electrically connects negative electrode terminal 301 and negative electrode tab group 220. Negative electrode current collector 410 in the present embodiment is connected to negative electrode terminal 301 between electrode assembly 200 and first sealing plate 120.

Negative electrode current collector 410 includes a first conductive member 430 (first component) and a second conductive member 440 (second component). First conductive member 430 and second conductive member 440 are joined to each other at a joining portion 433. First conductive member 430 and second conductive member 440 are joined by, for example, laser welding.

First conductive member 430 is joined to negative electrode tab group 220 at joining portion 434. Joining portion 434 can be formed by, for example, ultrasonic welding, resistance welding, laser welding, swaging, or the like. In the present embodiment, first conductive member 430 and negative electrode tab group 220 are joined by, for example, ultrasonic bonding.

Second conductive member 440 is connected to negative electrode terminal 301 at a joining portion 441. Joining portion 441 can be formed by, for example, ultrasonic welding, resistance welding, laser welding, swaging, or the like. In the present embodiment, negative electrode terminal 301 and second conductive member 440 are joined by, for example, providing a through hole in second conductive member 440, inserting negative electrode terminal 301 into the through hole, swaging negative electrode terminal 301 on second conductive member 440, and then welding the swaged portion and second conductive member 440.

First conductive member 430 has a first region 431 and a second region 432. First region 431 is connected to second conductive member 440. Second region 432 is connected to negative electrode tab group 220. Second region 432 is disposed along first sealing plate 120.

A stepped portion 435 is provided between first region 431 and second region 432. In a state after secondary battery 1 is assembled, the positions of first region 431 and second region 432 in the first direction (X direction) are made different by stepped portion 435. Thus, first region 431 and second region 432 can be arranged side by side in one direction. Stepped portion 435 extends along the third direction (Z direction).

A first insulating member 510 (resin member) is disposed between negative electrode terminal 301 and first sealing plate 120. A second insulating member 520 (resin member) is disposed between first sealing plate 120 and each of first conductive member 430 and second conductive member 440. It should be noted that first insulating member 510 and second insulating member 520 may be an integrated component.

Negative electrode terminal 301 is attached to first sealing plate 120 with first insulating member 510 being interposed therebetween. Negative electrode terminal 301 is provided to be exposed to the outside of first sealing plate 120 and reach second conductive member 440 of negative electrode current collector 410 provided on the inner surface side of first sealing plate 120.

As a procedure for assembling each component, first, negative electrode terminal 301 and second conductive member 440 as well as first insulating member 510 and second insulating member 520 are attached to first sealing plate 120. Next, first conductive member 430 electrically connected to electrode assembly 200 is attached to second conductive member 440. On this occasion, first conductive member 430 is disposed on first insulating member 510 such that a portion of first conductive member 430 overlaps with second conductive member 440. Next, first conductive member 430 and second conductive member 440 are welded and connected to each other at joining portion 434.

It should be noted that negative electrode terminal 301 may be electrically connected to first sealing plate 120. Further, first sealing plate 120 may serve as negative electrode terminal 301.

It should be noted that each of FIGS. 13 and 14 illustrates negative electrode current collector 410 constituted of two components (first conductive member 430 and second conductive member 440); however, negative electrode current collector 410 may be constituted of one component.

Each of FIGS. 13 and 14 shows the connection structure on the negative electrode side; however, the basic connection structure on the positive electrode side is the same as that on the negative electrode side.

### Step of Inserting Electrode Assembly 200

FIG. 15 is a diagram showing a step of inserting electrode assembly 200 into case main body 110. As shown in FIG. 15, insulating sheet 700 (electrode assembly holder) composed of a resin is disposed between electrode assembly 200 and case main body 110.

Insulating sheet 700 may be composed of, for example, a resin. More specifically, the material of insulating sheet 700 is, for example, polypropylene (PP), polyethylene terephthalate (PET), polyphenylene sulfide (PPS), polyimide (PI), or polyolefin (PO).

Insulating sheet 700 does not necessarily need to cover a whole of the surfaces of electrode assembly 200. Insulating sheet 700 preferably covers an area of about 50% or more, more preferably about 70% or more, of the outer surfaces of the electrode assembly. Insulating sheet 700 preferably covers a whole of at least four surfaces of the six surfaces of electrode assembly 200 having a substantially rectangular parallelepiped shape (flat shape) other than the two surfaces thereof on which negative electrode tab group 220 and positive electrode tab group 250 are formed respectively.

Before the step of inserting electrode assembly 200 into case main body 110, each of first sealing plate 120, negative electrode terminal 301, and negative electrode tab group 220 is joined. After the step of inserting electrode assembly 200 into case main body 110, each of second sealing plate 130, positive electrode terminal 302, and positive electrode tab group 250 is joined.

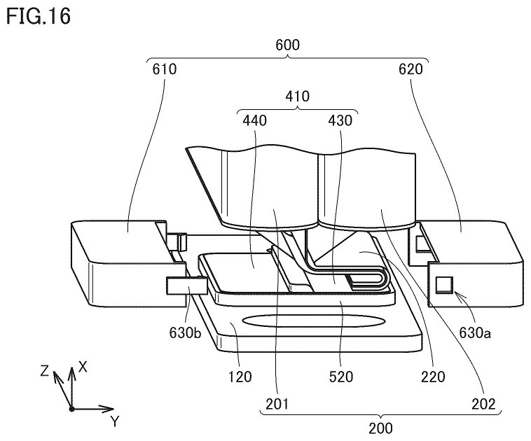

FIG. 16 is a diagram showing a step of disposing a spacer 600 between first sealing plate 120 and electrode assembly 200.

As shown in FIG. 16, negative electrode tab group 220 extends from electrode assembly 200 toward first sealing plate 120 in the following manner: negative electrode tab group 220 extends from the central portion of first sealing plate 120 to an end portion of first sealing plate 120 in the Y direction and is then bent to be folded back toward the central portion in an opposite direction. Spacer 600 is provided to store the curved part of negative electrode tab group 220. The configuration of negative electrode tab group 220 will be described in detail later.

Spacer 600 includes a first spacer 610 and a second spacer 620. First spacer 610 and second spacer 620 are slid along the Y direction from the respective end portion sides to the center side of first sealing plate 120, and are accordingly engaged with each other by engagement portions 630a, 630b. Thus, spacer 600 is fixed to first sealing plate 120 with first insulating member 510 being interposed therebetween, thereby increasing stability of the position of spacer 600.

### Joining Structure Between Electrode Assembly 200 and Electrode Terminal 300

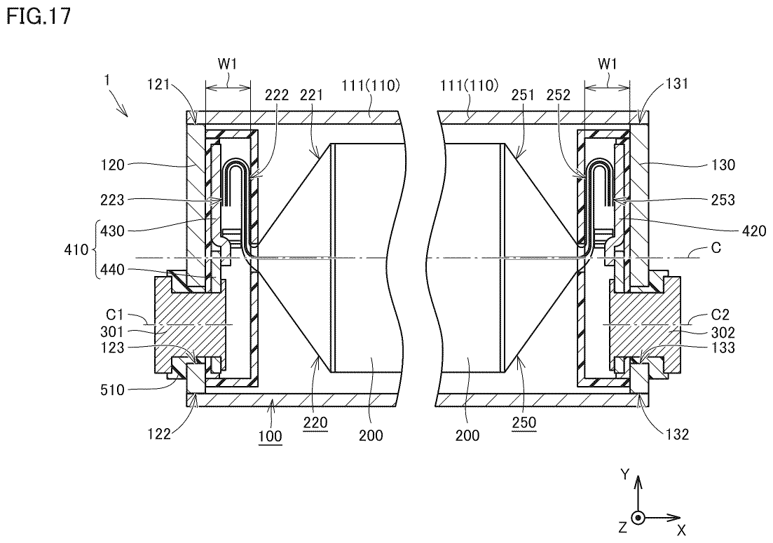

FIG. 17 is a partial cross sectional view of the secondary battery according to the embodiment when viewed from above. As shown in FIG. 17, negative electrode tab group 220 of electrode assembly 200 has a root portion 221, a first bent portion 222, and a first tip side region 223.

Root portion 221 is a portion of negative electrode tab group 220 adjacent to the negative electrode plate. In root portion 221, the plurality of negative electrode tabs extending from the negative electrode plate to the end portion on the first side (the first sealing plate 120 side) in the first direction (X direction) are collected in a direction toward the end portion on the first side.

In first bent portion 222, the plurality of negative electrode tabs are collected and stacked. First bent portion 222 is connected to an end portion of root portion 221 on the first side in the first direction (X direction).

Negative electrode tab group 220 is bent at first bent portion 222 such that the tip side of negative electrode tab group 220 with respect to first bent portion 222 is directed to the second end portion 122 side in the second direction (Y direction). First bent portion 222 is collectively bent so as to be folded back to the opposite side in the second direction (Y direction). First bent portion 222 in the present embodiment is collectively bent from root portion 221 to the first end portion 121 side in the second direction (Y direction) and is then collectively folded back to the second end portion 122 side.

First bent portion 222 is located on the first end portion 121 side with respect to center C of first sealing plate 120 in the second direction (Y direction). It should be noted that first bent portion 222 including the portion collectively extending straightly in the second direction (Y direction) in the present embodiment is located on the first end portion 121 side with respect to center C of first sealing plate 120, but is not limited to this configuration. First bent portion 222 may be configured such that at least only its curved part is located on the first end portion 121 side with respect to center C of first sealing plate 120.

First tip side region 223 is a region located on the tip side of negative electrode tab group 220 with respect to first bent portion 222. First tip side region 223 in the present embodiment is electrically connected to negative electrode terminal 301 via negative electrode current collector 410. First tip side region 223 is joined to first conductive member 430 of negative electrode current collector 410.

First sealing plate 120 is provided with a first through hole 123 in which negative electrode terminal 301 is inserted in the first direction (X direction). Center C1 of first through hole 123 is located on the second end portion 122 side with respect to center C of first sealing plate 120 in the second direction (Y direction). It should be noted that the entire opening of first through hole 123 is located on the second end portion 122 side with respect to center C of first sealing plate 120, but it is not limited to this configuration. Center C1 of first through hole 123 may be located on the second end portion 122 side with respect to center C of first sealing plate 120, and a portion of the opening of first through hole 123 may be located on the first end portion 121 side with respect to center C of first sealing plate 120.

First through hole 123 preferably has a perfect circular shape. However, first through hole 123 may have a polygonal shape, an elliptical shape, a track shape, or the like. In the case of each of these shapes, center C1 of first through hole 123 is the position of the center of gravity when viewed in the first direction (X direction).

Since center C1 of first through hole 123 is located on the second end portion 122 side with respect to center C of first sealing plate 120 in the second direction (Y direction), the central axis of negative electrode terminal 301 disposed inside first through hole 123 is also located on the second end portion 122 side with respect to center C of first sealing plate 120 in the second direction (Y direction). Thus, negative electrode terminal 301 and first bent portion 222 of negative electrode tab group 220 are disposed so as not to overlap with each other in the first direction (X direction).

It should be noted that first bent portion 222 may be arranged to overlap, in the second direction (Y direction), with a portion of negative electrode terminal 301 joined to negative electrode current collector 410, depending on a degree of bending of negative electrode tab group 220. Further, negative electrode terminal 301 may not necessarily extend in the first direction (X direction) at a portion from first through hole 123 to the outer surface of first sealing plate 120.

Positive electrode tab group 250 of electrode assembly 200 has a root portion 251, a second bent portion 252, and a second tip side region 253.

Root portion 251 is a portion of positive electrode tab group 250 adjacent to the positive electrode plate. In root portion 251, the plurality of positive electrode tabs extending from the second electrode to the end portion on the second side (the second sealing plate 130 side) in the first direction are collected in a direction toward the end portion on the second side.

In second bent portion 252, the plurality of positive electrode tabs are collected and stacked. Second bent portion 252 is connected to an end portion of root portion 251 on the second side in the first direction (X direction).

Positive electrode tab group 250 is bent at second bent portion 252 such that the tip side of positive electrode tab group 250 with respect to second bent portion 252 is directed to the fourth end portion 132 side in the second direction (Y direction). Second bent portion 252 is collectively bent so as to be folded back to the opposite side in the second direction (Y direction). Second bent portion 252 in the present embodiment is collectively bent from root portion 251 to the third end portion 131 side in the second direction (Y direction), and is then collectively folded back to the fourth end portion 132 side.

Second bent portion 252 is located on the third end portion 131 side with respect to center C of second sealing plate 130 in the second direction (Y direction). It should be noted that second bent portion 252 including the portion collectively extending straightly in the second direction (Y direction) in the present embodiment is located on the third end portion 131 side with respect to center C of second sealing plate 130, but it is not limited to this configuration. Second bent portion 252 may be configured such that at least only its curved part is located on the third end portion 131 side with respect to center C of second sealing plate 130.

Second tip side region 253 is a region located on the tip side of positive electrode tab group 250 with respect to second bent portion 252. Second tip side region 253 in the present embodiment is electrically connected to positive electrode terminal 302 via positive electrode current collector 420.

First bent portion 222 and second bent portion 252 in the present embodiment are bent to the same side in the second direction (Y direction). Therefore, when forming first bent portion 222 and second bent portion 252 by folding, the folding directions are the same, thereby facilitating the folding processing. It should be noted that first bent portion 222 and second bent portion 252 may be folded to opposite sides in the second direction (Y direction).

Second sealing plate 130 is provided with a second through hole 133 in which positive electrode terminal 302 is inserted in the first direction (X direction). Center C2 of second through hole 133 is located on the fourth end portion 132 side with respect to center C of second sealing plate 130 in the second direction (Y direction). It should be noted that the entire opening of second through hole 133 is located on the fourth end portion 132 side with respect to center C of second sealing plate 130, but it is not limited to this configuration. Center C2 of second through hole 133 may be located on the fourth end portion 132 side with respect to center C of second sealing plate 130, and a portion of the opening of second through hole 133 may be located on the third end portion 131 side with respect to center C of second sealing plate 130.

Second through hole 133 preferably has a perfect circular shape. However, second through hole 133 may have a polygonal shape, an elliptical shape, a track shape, or the like. In the case of each of these shapes, center C2 of second through hole 133 is the position of the center of gravity when viewed in the first direction (X direction).

First through hole 123 and second through hole 133 in the present embodiment are provided on the same side when viewed from center C of each of first sealing plate 120 and second sealing plate 130 in the second direction (Y direction). Therefore, when first bent portion 222 and second bent portion 252 are bent to the same side in the second direction (Y direction), electrical connection to them is facilitated to be made.

Since center C2 of second through hole 133 is located on the fourth end portion 132 side with respect to center C of second sealing plate 130 in the second direction (Y direction), positive electrode terminal 302 disposed inside second through hole 133 is also located on the fourth end portion 132 side with respect to center C of second sealing plate 130 in the second direction (Y direction). Thus, positive electrode terminal 302 and second bent portion 252 of positive electrode tab group 250 are disposed so as not to overlap with each other in the first direction (X direction).

It should be noted that second bent portion 252 may be arranged to overlap, in the second direction (Y direction), with a portion of positive electrode terminal 302 joined to positive electrode current collector 420, depending on a degree of bending of positive electrode tab group 250. Further, positive electrode terminal 302 may not necessarily extend in the first direction (X direction) at a portion from second through hole 133 to the outer surface of second sealing plate 130.

As shown in FIG. 17, in secondary battery 1 according to the embodiment, negative electrode terminal 301 and first bent portion 222 of negative electrode tab group 220 are disposed so as not to overlap with each other in the first direction (X direction). That is, negative electrode terminal 301 and first bent portion 222 are disposed to be displaced from each other in the second direction (Y direction) when viewed in the first direction (X direction). Thus, negative electrode terminal 301 and first bent portion 222 can be less likely to interfere with each other in the first direction (X direction). Therefore, an occupied width W1 of first bent portion 222, negative electrode current collector 410, and negative electrode terminal 301 in the first direction (X direction) inside case 100 can be further narrowed. As a result, an occupied volume of the negative electrode plate and the positive electrode plate of electrode assembly 200 inside case 100 can be large, thus resulting in a large energy density of secondary battery 1.

Further, since first bent portion 222 is disposed on the first end portion 121 side, negative electrode tab group 220 is readily bent to facilitate formation of first bent portion 222 as compared with the configuration in which the first bent portion is disposed in the vicinity of center C in the second direction (Y direction), with the result that secondary battery 1 can be efficiently manufactured.

It should be noted that the connection structure on the negative electrode side of the secondary battery in the present embodiment has been described, and the connection structure on the positive electrode side is the same as the connection structure on the negative electrode side.

In secondary battery 1 according to the embodiment of the present technology, first bent portion 222 of negative electrode tab group 220 of electrode assembly 200 and center C1 of first through hole 123 in which negative electrode terminal 301 is inserted are disposed so as not to overlap with each other in the first direction (X direction). Thus, first bent portion 222 and negative electrode terminal 301 can be avoided from interfering with each other in the first direction (X direction). Therefore, as compared with the case where first bent portion 222 and negative electrode terminal 301 disposed in first through hole 123 are disposed to overlap with each other in the first direction (X direction), occupied width W1 of negative electrode tab group 220 and negative electrode terminal 301 in the first direction (X direction) can be narrowed. As a result, the occupied volume of the negative electrode plate and the positive electrode plate of electrode assembly 200 inside case 100 can be large, thus resulting in an improved energy density of secondary battery 1.

In secondary battery 1 according to the embodiment of the present technology, as with the configuration on the negative electrode side, second bent portion 252 of positive electrode tab group 250 of electrode assembly 200 and center C2 of second through hole 133 in which positive electrode terminal 302 is inserted are disposed so as not to overlap with each other in the first direction (X direction). Thus, second bent portion 252 and positive electrode terminal 302 can be less likely to interfere with each other in the first direction (X direction). Therefore, as compared with the case where second bent portion 252 and positive electrode terminal 302 disposed in second through hole 133 are disposed to overlap with each other in the first direction (X direction), an occupied width W1 of positive electrode tab group 250 and positive electrode terminal 302 in the first direction (X direction) can be narrowed. As a result, the occupied volume of the negative electrode plate and the positive electrode plate of electrode assembly 200 inside case 100 can be large, thus resulting in an improved energy density of secondary battery 1.

In secondary battery 1 according to the embodiment of the present technology, since the folding directions for forming first bent portion 222 of negative electrode tab group 220 and second bent portion 252 of positive electrode tab group 250 are the same, the bent portions can be facilitated to be folded stably as compared with the case where first bent portion 222 and second bent portion 252 are folding to opposite sides, with the result that electrode assembly 200 can be efficiently manufactured.

In secondary battery 1 according to the embodiment of the present technology, since stepped portion 435 is provided between first region 431 and second region 432 of first conductive member 430 of negative electrode current collector 410, the positions of first region 431 and second region 432 in the first direction (X direction) can be different. Therefore, first region 431 of first conductive member 430 of negative electrode current collector 410 and second conductive member 440 can overlap with each other in the second direction (Y direction), and second region 432 of first conductive member 430 can be disposed closer to first sealing plate 120. Thus, occupied width W1 of negative electrode tab group 220, negative electrode current collector 410, and negative electrode terminal 301 in the first direction (X direction) can be further narrowed. As a result, the occupied volume of the negative electrode plate and the positive electrode plate of electrode assembly 200 inside case 100 can be large, thus resulting in an improved energy density of secondary battery 1. It should be noted that when positive electrode current collector 420 has the same structure as that of negative electrode current collector 410, the same effect can be exhibited.

In secondary battery 1 according to the embodiment of the present technology, since second region 432 of first conductive member 430 of negative electrode current collector 410 is disposed to face first sealing plate 120 along first sealing plate 120, occupied width W1 of negative electrode tab group 220, negative electrode current collector 410, and negative electrode terminal 301 in the first direction (X direction) of electrode assembly 200 can be further narrowed. As a result, the occupied volume of the negative electrode plate and the positive electrode plate of electrode assembly 200 can be large, thus resulting in an improved energy density of secondary battery 1.

Hereinafter, secondary batteries according to modifications of the embodiment will be described. In a secondary battery according to the present modification, the structure of the case is different from that of secondary battery 1 according to the embodiment of the present technology and the same configuration as that of secondary battery 1 according to the embodiment of the present technology will not be therefore described repeatedly.

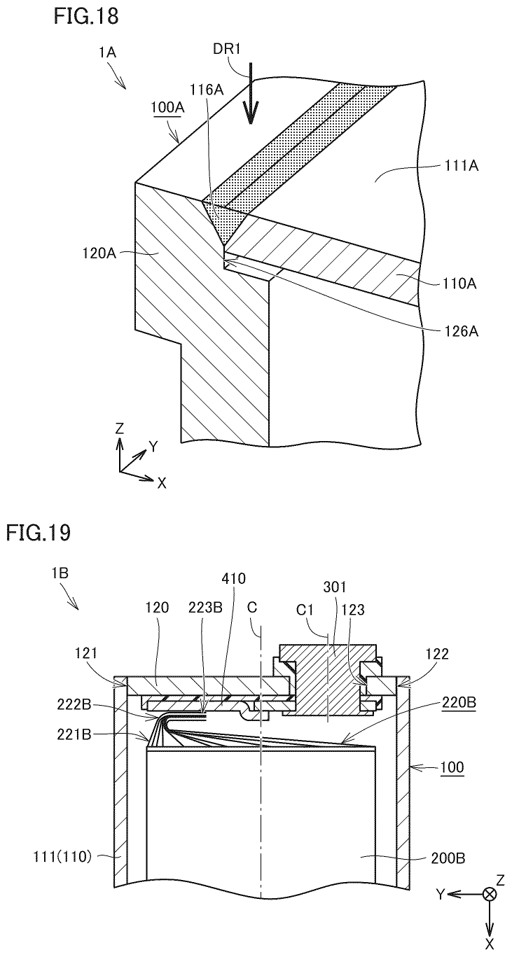

FIG. 18 is a perspective view showing a joining state between a case main body and a first sealing plate included in a secondary battery according to a first modification of the embodiment. It should be noted that configurations other than the case are not shown in FIG. 18.

As shown in FIG. 18, a secondary battery 1A according to the first modification of the embodiment includes a case 100A. Case 100A includes a case main body 110A and a first sealing plate 120A.

First sealing plate 120A has a covering portion 126A that covers an end portion of case main body 110A on the first side in the first direction (X direction). Covering portion 126A and case main body 110A are joined by welding.

A joining portion 116A is formed between covering portion 126A and an outer peripheral surface 111A of case main body 110A. Since joining portion 116A is located at outer peripheral surface 111A of case main body 110A, joining portion 116A can be disposed at a position away from the insulating member provided between the negative electrode terminal and the first sealing plate as compared with the case where the whole of the first sealing plate is inserted in the inner peripheral surface of the case main body and the joining portion is formed between the outer peripheral surface of the first sealing plate and the inner peripheral surface of the case main body.

Joining portion 116A can be joined, for example, by applying an energy ray from the outer peripheral surface 111A side (DR1 direction in FIG. 18) of case main body 110A. Joining portion 116A in the present embodiment is formed by, for example, laser welding. In this case, even if the laser passes through the joining location between covering portion 126A and case main body 110A, the laser can be received by a portion of first sealing plate 120A that is along the first direction (X direction) and that is bent from covering portion 126A. Therefore, penetration of the laser during the laser welding can be suppressed. It should be noted that FIG. 18 shows the configuration on the negative electrode side; however, the same structure as that on the negative electrode side can also be formed on the positive electrode side.

In secondary battery 1A according to the modification of the embodiment of the present technology, when joining case main body 110A and first sealing plate 120A by laser welding or the like, covering portion 126A located on the outer periphery of first sealing plate 120A and outer peripheral surface 111A of case main body 110A are joined. Thus, case main body 110A and first sealing plate 120A can be joined in a state in which the joining location between first sealing plate 120A and case main body 110A is separated as far as possible from the insulating member composed of a resin and provided between negative electrode terminal 301 and first sealing plate 120A. As a result, thermal influence at the time of joining of joining portion 116A to the insulating member can be suppressed to suppress deformation or the like of the insulating member, thereby improving reliability of the secondary battery. It should be noted that when the same configuration as that on the negative electrode side is provided on the positive electrode side, the same effect is exhibited.

FIG. 19 is a partial cross sectional view showing a configuration of a secondary battery according to a second modification of the embodiment. As shown in FIG. 19, a secondary battery 1B according to the second modification of the embodiment includes case 100 and an electrode assembly 200B. Negative electrode tab group 220B in electrode assembly 200B has a root portion 221B, a first bent portion 222B, and a first tip side region 223B.

Root portion 221B is a portion of negative electrode tab group 220B adjacent to the negative electrode plate. In root portion 221B, a plurality of negative electrode tabs extending from the negative electrode plate to the end portion on the first side (first sealing plate 120 side) in the first direction (X direction) are collected in the direction toward the end portion on the first side.

In first bent portion 222B, the plurality of negative electrode tabs are collected and stacked. First bent portion 222B of the present modification is provided with a clearance between the plurality of negative electrode tabs in a range from the end portion on the root portion 221B side to its curved part.

First tip side region 223B is a region located on the tip side of negative electrode tab group 220B with respect to first bent portion 222B. It should be noted that the connection structure on the negative electrode side of the secondary battery has been described in the present modification; however, the connection structure on the positive electrode side is the same as the connection structure on the negative electrode side.

Also in secondary battery 1B according to the second modification of the embodiment of the present technology, as with the embodiment, first bent portion 222B of negative electrode tab group 220B of electrode assembly 200B and center C1 of first through hole 123 in which negative electrode terminal 301 is inserted are disposed so as not to overlap with each other in the first direction (X direction). Thus, first bent portion 222B and negative electrode terminal 301 can be avoided from interfering with each other in the first direction (X direction). Therefore, as compared with the case where first bent portion 222B and negative electrode terminal 301 disposed in first through hole 123 are disposed to overlap with each other in the first direction (X direction), the occupied width of negative electrode tab group 220B and negative electrode terminal 301 in the first direction (X direction) can be narrowed. As a result, the occupied volume of the negative electrode plate and the positive electrode plate of electrode assembly 200B inside case 100 can be large, thus resulting in an improved energy density of secondary battery 1B. It should be noted that when the same configuration as that on the negative electrode side is provided on the positive electrode side, the same effect is exhibited.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A secondary battery comprising:
an electrode assembly including a first electrode and a second electrode having a polarity different from a polarity of the first electrode;
a case that accommodates the electrode assembly; and
a first electrode terminal electrically connected to the first electrode and provided in the case, wherein
the electrode assembly includes a first electrode tab group and a second electrode tab group, the first electrode tab group being electrically connected to the first electrode, the first electrode tab group being located at an end portion of the electrode assembly on a first side in a first direction, the second electrode tab group being electrically connected to the second electrode, the second electrode tab group being located at an end portion of the electrode assembly on a second side opposite to the first side in the first direction,
the case includes a case main body provided with a first opening located at an end portion of the case main body on the first side in the first direction, and a first sealing plate that seals the first opening,
the first sealing plate has a first end portion and a second end portion located opposite to each other in a second direction orthogonal to the first direction,
the first electrode tab group has a first bent portion that is collectively bent, and a first tip side region located on a tip side of the first electrode tab group with respect to the first bent portion,
the first electrode tab group is bent at the first bent portion such that the tip side of the first electrode tab group with respect to the first bent portion is directed to the second end portion side,
the first tip side region is electrically connected to the first electrode terminal,
the first sealing plate is provided with a first through hole in which the first electrode terminal is inserted in the first direction,
the first bent portion is located on the first end portion side with respect to a center of the first sealing plate in the second direction, and
a center of the first through hole is located on the second end portion side with respect to the center of the first sealing plate in the second direction.

2. The secondary battery according to claim 1, further comprising a second electrode terminal electrically connected to the second electrode and provided in the case, wherein
the case includes a second sealing plate,
the case main body is provided with a second opening located at an end portion of the case main body on the second side in the first direction,
the second sealing plate seals the second opening,
the second sealing plate has a third end portion and a fourth end portion located opposite to each other in the second direction,
the second electrode tab group has a second bent portion that is collectively bent, and a second tip side region located on a tip side of the second electrode tab group with respect to the second bent portion,
the second electrode tab group is bent at the second bent portion such that the tip side of the second electrode tab group with respect to the second bent portion is directed to the second end portion side,
the second tip side region is electrically connected to the second electrode terminal,
the second sealing plate is provided with a second through hole in which the second electrode terminal is inserted in the first direction,
the second bent portion is located on the third end portion side with respect to a center of the second sealing plate in the second direction, and
a center of the second through hole is located on the fourth end portion side with respect to the center of the second sealing plate in the second direction.

3. The secondary battery according to claim 2, wherein in the second direction, the first end portion and the third end portion are located on the same end portion side.

4. The secondary battery according to claim 1, further comprising a first current collector member that electrically connects the first electrode terminal and the first electrode tab group, wherein
the first current collector member includes a first component and a second component,
the second component is connected to the first electrode terminal,
the first component has a first region connected to the second component and a second region connected to the first electrode tab group,
a stepped portion is provided between the first region and the second region such that positions of the first region and the second region in the first direction are different from each other, and
the stepped portion extends along a third direction orthogonal to the first direction and the second direction.

5. The secondary battery according to claim 2, further comprising a first current collector member that electrically connects the first electrode terminal and the first electrode tab group, wherein
the first current collector member includes a first component and a second component,
the second component is connected to the first electrode terminal,
the first component has a first region connected to the second component and a second region connected to the first electrode tab group,
a stepped portion is provided between the first region and the second region such that positions of the first region and the second region in the first direction are different from each other, and
the stepped portion extends along a third direction orthogonal to the first direction and the second direction.

6. The secondary battery according to claim 3, further comprising a first current collector member that electrically connects the first electrode terminal and the first electrode tab group, wherein
the first current collector member includes a first component and a second component,
the second component is connected to the first electrode terminal,
the first component has a first region connected to the second component and a second region connected to the first electrode tab group,
a stepped portion is provided between the first region and the second region such that positions of the first region and the second region in the first direction are different from each other, and
the stepped portion extends along a third direction orthogonal to the first direction and the second direction.

7. The secondary battery according to claim 4, wherein the second region of the first component is disposed along the first sealing plate.

8. The secondary battery according to claim 5, wherein the second region of the first component is disposed along the first sealing plate.

9. The secondary battery according to claim 6, wherein the second region of the first component is disposed along the first sealing plate.

10. The secondary battery according to claim 1, further comprising a resin member disposed between the first electrode terminal and the first sealing plate, wherein
the first sealing plate further has a covering portion that covers, in the first direction, the end portion of the case main body on the first side, and
the covering portion and the case main body are joined by welding.

11. The secondary battery according to claim 2, further comprising a resin member disposed between the first electrode terminal and the first sealing plate, wherein
the first sealing plate further has a covering portion that covers, in the first direction, the end portion of the case main body on the first side, and
the covering portion and the case main body are joined by welding.
